(19) United States
(12) Patent Application Publication
(10) Pub. No.: US 2025/0169545 A1
(43) Pub. Date: May 29, 2025

(54) Aerosol Generating Device Including a Magnet as a Safety Fuse

(71) Applicant: JT International SA, Geneva (CH)

(72) Inventors: Pier Paolo Monticone, Le Grand Saconnex (CH); Layth Sliman Bouchiguir, Bellevue (CH)

(73) Assignee: JT International SA, Geneva (CH)

(21) Appl. No.: 18/730,476

(22) PCT Filed: Jan. 20, 2023
(86) PCT No.: PCT/EP2023/051350

§ 371 Date: Jul. 19, 2024

(30) Foreign Application Priority Data
Jan. 21, 2022 (EP) 22152664.3

(51) Int. Cl. A24F 40/51; A24F 40/46; A24F 40/53; A24F 40/60; G01K 3/00; G01K 7/36; H01F 7/02

(52) U.S. Cl. CPC A24F 40/51; A24F 40/46; A24F 40/53; A24F 40/60; G01K 3/005; G01K 7/36; H01F 7/02

(57) ABSTRACT

An aerosol generating device includes a magnet, a sensor and a disabling unit. The magnet is configured to generate a magnetic field. The sensor is coupled to the magnet and configured to sense a value of a magnetic field generated by the magnet. The disabling unit is configured to disable operation of the aerosol generating device, wherein the disabling unit is configured to disable operation of the aerosol generating device in correspondence of a magnetic field value detected by the sensor being below a predetermined magnetic field threshold, wherein the predetermined magnetic field threshold includes a value indicating an intensity of the magnetic field exhibited by the magnet in correspondence of a maximum operating temperature of the magnet, the maximum operating temperature of the magnet indicating a temperature value above which the magnet loses magnetic properties.

### TECHNICAL FIELD

The present invention generally relates to the field of aerosol generation devices. In particular, the present invention is directed to an aerosol generating device capable of disabling its operation, a disabling unit for disabling operation of an aerosol generating device, a method for disabling operation of an aerosol generating device and a computer program.

### BACKGROUND

Fuses are known as electrical safety components used to protect an electrical or electronic device in cases of malfunctions and/or in order to prevent hazardous or dangerous situations.

### SUMMARY OF THE INVENTION

### Technical Problem

It is conceivable applying a safety component like a fuse to an aerosol generating device. However, such conceivable solution is not particularly suitable to an aerosol generating device; also, known safety solutions for an aerosol generating device are not particularly effective or practical.

### SUMMARY OF THE SOLUTION

One of the objects of the present disclosure is to improve existing aerosol generating devices, in particular their safety or safe operation, and in general to address one or more of the prior art technical problems as for example above summarized.

According to aspect A1, it is provided an aerosol generating device (1) including:
a magnet (10) configured to generate a magnetic field;
a sensor (20) coupled to the magnet and configured to sense a value of a magnetic field generated by the magnet;
a disabling unit (30) configured to disable operation of the aerosol generating device, wherein
the disabling unit (30) is configured to disable operation of the aerosol generating device (1) in correspondence of a magnetic field value detected by the sensor (20) being below a predetermined magnetic field threshold, wherein the predetermined magnetic field threshold includes a value indicating an intensity of the magnetic field exhibited by the magnet (10) in correspondence of a maximum operating temperature of the magnet (10), the maximum operating temperature of the magnet indicating a temperature value above which the magnet loses magnetic properties.

Aspect A2: The aerosol generating device (1) of aspect A1, wherein the magnet (10) and the sensor (20) are in a fixed position relatively to each other.

Aspect A3: The aerosol generating device (1) of aspect A1 or A2, wherein the maximum operating temperature of the magnet (10) corresponds to a safe operating temperature at a location where the magnet (10) is placed.

Aspect A4. The aerosol generating device (1) of any of the preceding aspects A1 to A3, the aerosol generating device further including a temperature measurement unit (30) configured to provide a measure of temperature based on a value of the magnetic field sensed by the sensor (20).

Aspect A5: The aerosol generating device (1) of any of the preceding aspects A1 to A4, the aerosol generating device further including a heating unit, wherein the magnet (10) is placed in proximity of and/or in contact with and/or within the heating unit.

Aspect A6: The aerosol generating device (1) of aspect A5, wherein the magnet being placed within the heating unit includes the magnet being integrated as part of the construction of the heating unit, preferably as part of a wall of the heating unit or as part of a supporting member of the heating unit or as part of a plug of the heating unit.

Aspect A7: The aerosol generating device (1) of any of the preceding aspects A1 to A6, the aerosol generating device further including a battery, wherein the magnet (10) is placed in proximity of and/or in contact with the battery.

Aspect A8: The aerosol generating device (1) of any of the preceding aspects A1 to A7, wherein the disabling unit includes a switch connected in series to the battery and that is configured to be an open position when the magnetic field is below the magnetic field threshold.

Aspect A9: A disabling unit (230) for disabling operation of an aerosol generating device (1) including a magnet (10) or operation of an accessory apparatus of an aerosol generating device (1), the accessory apparatus including a magnet (10), the disabling unit (1) including:
a processing unit (231) configured to determine a disablement condition in correspondence of a magnetic field value of the magnet being below a predetermined magnetic field threshold, wherein the predetermined magnetic field threshold includes a value indicating an intensity of the magnetic field exhibited by the magnet in correspondence of a maximum operating temperature of the magnet, the maximum operating temperature of the magnet indicating a temperature value above which the magnet loses magnetic properties;
a notification unit (232) configured to issue, in response to the determination of a presence of the disablement condition, a notification signal indicating that operation of the aerosol generation device or that operation of the accessory apparatus is to be disabled.

Aspect A10: The disabling unit (230) according to aspect A9, wherein the magnet (10) and the sensor (20) are in a fixed position relatively to each other.

Aspect A11: The disabling unit (230) according to aspect A9 or A10, wherein the maximum operating temperature of the magnet (10) corresponds to a safe operating temperature at a location where the magnet (10) is placed.

Aspect A12. The disabling unit (230) according to any of aspects A9 to A11, wherein the disabling unit is configured to receive, from a temperature measurement unit, a measure of temperature based on a value of the magnetic field sensed by the sensor (20).

Aspect A13: The disabling unit (230) according to any of aspects A9 to A12, wherein the magnet (10) is placed in proximity of and/or in contact with and/or within the heating unit.

Aspect A14: The disabling unit (230) according to any of aspect A13, wherein the magnet being placed within the heating unit includes the magnet being integrated as part of the construction of the heating unit, preferably as part of a wall of the heating unit or as part of a supporting member of the heating unit or as part of a plug of the heating unit.

Aspect A15: The disabling unit (230) according to any of aspects A9 to A14, the aerosol generating device further including a battery, wherein the magnet (10) is placed in proximity of and/or in contact with the battery.

Aspect A16: The disabling unit (230) according to any of aspects A9 to A15, wherein the disabling unit includes a switch connected in series to the battery and that is configured to be an open position when the magnetic field is below the magnetic field threshold.

Aspect A17: A method for disabling operation of an aerosol generating device including a magnet, the method comprising the steps of:
Measuring (S10), by means of a sensor coupled to a magnet included in the aerosol generating device, a value of a magnetic field generated by the magnet;
disabling (S10) operation of the aerosol generating device in correspondence of a magnetic field value being below a predetermined magnetic field threshold, wherein the predetermined magnetic field threshold includes a value indicating an intensity of the magnetic field exhibited by the magnet in correspondence of a maximum operating temperature of the magnet, the maximum operating temperature of the magnet indicating a temperature value above which the magnet loses magnetic properties.

Aspect A18: The method of aspect A17, wherein the magnet (10) and the sensor (20) are placed in a fixed position relatively to each other.

Aspect A19: The method of aspect A17 or A18, wherein the maximum operating temperature of the magnet (10) corresponds to a safe operating temperature at a location where the magnet (10) is placed.

Aspect A20. The method of any of the preceding aspects A17 to A19, further including a step of measuring a temperature (corresponding to the temperature at a location where the magnet is placed) based on a value of the magnetic field sensed by the sensor (20).

Aspect A21: The method of the preceding aspects A17 to A20, the aerosol generating device further including a heating unit, wherein the magnet (10) is placed (or placing the magnet) in proximity of and/or in contact with and/or within the heating unit.

Aspect A22: The method of aspect A21, wherein the magnet being placed within the heating unit includes the magnet being integrated as part of the construction of the heating unit, preferably as part of a wall of the heating unit or as part of a supporting member of the heating unit or as part of a plug of the heating unit.

Aspect A23: The method of any of the preceding aspects A17 to A22, the aerosol generating device further including a battery, wherein the magnet (10) is placed (placing the magnet) in proximity of and/or in contact with the battery.

Aspect A24: The aerosol generating device (1) of any of the preceding aspects A17 to A23, wherein the disabling unit includes a switch connected in series to the battery and the method includes the step of switching the switch in an open position when the magnetic field is below the magnetic field threshold.

Aspect A25: A computer program including instructions which, when executed on a computer, cause the computer to perform the steps of any of aspects A17 to A25.

### BRIEF DESCRIPTION OF THE DRAWINGS

Embodiments of the invention will now be explained in detail, by way of non-limiting example only, with reference to the accompanying figures, described below. Like reference numerals appearing in different ones of the figures can denote identical or functionally similar elements, unless indicated otherwise.

FIG. 1A is a schematic representation of an aerosol generating device according to an embodiment;

FIG. 1B is a schematic representation of an aerosol generating device according to an embodiment;

FIG. 2 is a schematic representation of a disabling unit according to an embodiment;

FIG. 3 is a flow chart of a method according to an embodiment;

FIG. 4 is a schematic representation of a computer suitable for executing a computer program for executing a method according to an embodiment;

FIG. 5A shows a cross section of an exemplary Heat Not Burn (HNB) device according to an embodiment;

FIG. 5B shows an illustrative maximum device operating temperatures heat map for the device of FIG. 5A;

FIG. 6A shows a schematic block of an HNB device according to an embodiment;

FIG. 6B shows an example for the configuration of FIG. 6A where the magnet is placed outside the heater;

FIG. 7A shows a schematic block of an HNB device according to an embodiment;

FIG. 7B shows an example for the configuration of FIG. 7A where the magnet is part of the heater construction, for example part of the heater cup construction;

FIG. 8A shows a schematic block of an HNB device according to an embodiment;

FIG. 8B shows an example for the configuration of FIG. 8A where the magnet is provided as a heater (oven) plug;

FIG. 9A shows a schematic block of an HNB device according to an embodiment;

FIG. 9B shows an example for the configuration of FIG. 9A where a heater cup is made from magnetic material as part thereof;

FIG. 10A shows a schematic block of an HNB device according to an embodiment;

FIG. 10B shows an example for the configuration of FIG. 10A where the Hall sensor is placed in proximity or touching the battery.

### DETAILED DESCRIPTION

Example embodiments of the present invention will now be described in detail with reference to the accompanying drawings. Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

According to an exemplifying illustration of the present solution, it is provided a safety fuse to disable, preferably permanently, an aerosol generating device like a Heat Not Burn (HNB) device, in particular to protect users from dangers that might be caused by overheating of damaged devices. For example, critical components like the heater (oven) or the battery may overheat, due e.g. to damage or malfunction, which may expose the user to a safety risk (e.g. getting burned) or which may damage further components (e.g. heat insulators) also resulting in exposing the user to safety risks. Such risks usually materialize in correspondence of a maximum functioning temperature of the aerosol generating device or of components thereof (e.g. the maximum functioning temperature of the heater and/or battery and/or heat insulator(s), etc.); this temperature might thus be considered as a maximum temperature within which a safe operation can be ensured at least to a certain extent as foreseen e.g. by the design, etc. Moreover, as long as the maximum temperature is not reached, this solution can be used as a wireless temperature sensor facilitating e.g. the device heating management/control.

In one example, the presently disclosed solution may stop an overheating device from being used when, optionally and as an example, other heating detection elements have failed (such as a thermistor) by the detection of a permanent magnetic material reaching its maximum operating temperature, as a consequence of which the magnet becomes permanently demagnetized. In this example, since the disabling will only occur when other heating detection methods have failed, the device will be inoperable adding extra safety for the consumer and robust against firmware resetting as the device disabling is in hardware. The solution may however be implemented without or independently of other heating detection methods. Moreover, the permanent magnet may act as a temperature sensor until it has reached its maximum operating temperature; for example, a Nyodienium magnets lose 0.11% of their magnetism for every 1 degree Celsius rise in temperature, so that this magnetic-temperature profile can be used to derive a temperature from a measurement of the magnetic field. Further embodiment and examples are provided in the following.

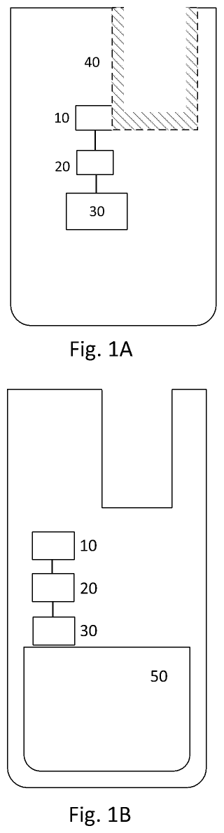

According to a first embodiment, it is provided an aerosol generating device including a magnet 10, a sensor (29) and a disabling unit 30 as shown for example in FIGS. 1A and 1B. It is noted that the same figures include optional elements like a heater 40 and a battery 50 according to two examples, namely the case wherein the magnet is placed in correspondence of a heater 40 (FIG. 1A) and of a battery 50 (FIG. 1B) as illustrated further below in detail.

The magnet 10 generates a magnetic field and is preferably a permanent magnet. A permanent magnet may be made from a material that is magnetized to provide a permanent or persistent magnetic field (e.g. as the result of the alignment induced on the magnetic domains), wherein the magnetic field remains substantially persistent over time at least within a range of temperatures. When the magnet is kept at a temperature below a maximum operating temperature (which may also be referred to as the Curie temperature), the magnetic property (e.g. the magnetic field) remains substantially unchanged over time at least for a given temperature or temperature range. Below the maximum operating temperature, the intensity of the magnetic field provided by the magnet may vary with temperature and, depending on the type of material, it may be inversely proportional to the temperature. However, the magnetization is substantially lost when the magnet finds itself or is heated beyond the maximum operating temperature.

The sensor 20 is coupled to the magnet 10 and configured to sense a value of a magnetic field generated by the magnet 10. Any sensor is suitable as long as it is capable of measuring a magnetic field produced a by magnet, in particular the intensity of the magnetic field and further in particular as produced or provided by a permanent magnet. Hence, coupled is to be understood also according to its common meaning as that the sensor is placed at a position relatively to the magnet, preferably in its proximity, so that the magnetic field produced by the magnet 10 can be detected by the sensor 20. Examples of the sensor 20 include one or any combination of a Hall sensor, a MEMS magnetic field sensor (based for example in measuring the Lorentz force), an AMR (Anisotropic Magneto Resistive) sensor, an GMR (Giant Magneto Resistive) sensor, a TMR (Tunnel Magneto Resistive), etc.

The disabling unit 30 is configured to disable the operation of the aerosol generating device when it is detected that the magnet has substantially lost its magnetic property, which substantially corresponds to the magnet being at a temperature that is equal to or larger than the maximum operating temperature. Having lost magnetic properties is to be understood as that the magnet is not anymore capable of generating alone a magnetic field, i.e. it has been demagnetized; this may also said to be irreversible, in the sense that the magnetic properties are not recovered if the material is left as it is (e.g. it may require a magnetization treatment as otherwise, left on its own as is also at temperatures below the maximum operating/Curie temperature, the magnetic properties would not be automatically recovered). In one example, the disabling unit 30 is configured to disable operation of the aerosol generating device in correspondence of a magnetic field value detected by the sensor 20 being below a predetermined magnetic field threshold; the predetermined magnetic field threshold includes or is a value indicating an intensity of the magnetic field exhibited by the magnet in correspondence of a maximum operating temperature of the magnet, the maximum operating temperature of the magnet indicating a temperature value above which the magnet loses magnetic properties. In other words, the intensity of the magnetic field corresponding to the magnetic field threshold is sufficiently low so that the magnetic properties of the magnet are not substantially detectable at least by the sensor 20. The magnetic field threshold may be predetermined based on the material of the magnet 10 and/or the sensor 20 (in particular, its accuracy in detecting low magnetic fields).

It is noted that the sensor 20 may provide a measure of the intensity of the magnetic field produced by the magnet 10 so that the disabling unit 30 may disable operation in correspondence of a low field value being below the predetermined magnetic field threshold. However, providing the measure of the field value is not required as it may in fact suffice to provide to the disabling unit 30 an indication that a magnetic field is present or absent (e.g. a flag value or an electric signal indicating that a magnetic field is detected as being above or respectively below the predetermined magnetic field threshold): also in this case, the disabling unit 30 is capable to disabling operation when the magnet has substantially lost its magnetic properties.

In one example, the disabling unit (30) may be included in or represented by a controller unit (a processor), which halts the operation of the aerosol generating device or of components. For example, the controller receives a signal from the sensor 20 and depending on the value of such signal, issues a command to disable operation of the aerosol generating device, e.g. a command turning the device off, halting operation of the controller/processor itself, disconnecting a battery unit from the heater, opening a switch so that power cannot be supplied to any or some of the components of the aerosol generating device, disconnecting the heater from other circuit(s), etc.

In another example, the disabling unit 30 may be represented by a transistor having one controlling terminal (e.g. the gate in the case of a MOSFET) and a pair of connectable terminals (e.g. the drain and the source in the case of a MOSFET), wherein the transistor is connected on a circuit line to be protected. The controlling terminal is provided with a signal indicating whether the magnetic field detected by the sensor 20 is below the predetermined magnetic field threshold (or whether a magnetic field of the magnet is detected to be present or absent): When the sensed magnetic field is absent or below the threshold, the transistor acts like an open switch so that no current flows between the two connectable terminals. The circuit line to be protected may include a circuit line connecting the battery unit to the heater, a circuit line connecting the battery to the rest of the electrical components of the aerosol generating device, a circuit line providing power to the heater, etc. The transistor is preferably connected within a circuit of the aerosol generating device so that the pair of connectable placed in series on the circuit line to terminals are protect. Although a MOSFET has been mentioned, the same applies to other types of transistors like FET, BJT, etc. Further, the disabling unit 30 may include the transistor and further electric components for properly handling the signal (e.g. adapting voltage value, inverting voltage values e.g. from the sensor to match with the controller/transistors, etc.). Furthermore, the disabling unit 30 may also be realized by an electro-mechanical component, e.g. a MEMS switch, a mechanical switch operated by transistors, etc.

As above explained, the disabling unit 30 may thus function as a fuse that disabled operation of the aerosol generating device.

The sensor 20 should be able to withstand certain temperatures; however, it is not necessarily required that the sensor should withstand the maximum operating temperature of the magnet 10. In fact, for the coupling between sensor 20 and magnet 10 to be sufficient to detect the magnetic field, it may suffice to have the sensor 20 placed in proximity of the magnet 10 but sufficiently away (where temperature drops) from the magnet 10 so that the temperature exhibited on the sensor 20 is lower than the maximum operating temperature of the magnet 10. In other words, it may suffice to have a sensor 20 capable of functioning a (e.g. providing measurement output within a predetermined accuracy) at a maximum functioning temperature being lower than the maximum operating temperature of the magnet 10.

Preferably, the magnet 10 and the sensor 20 are in a fixed position relatively to each other. In this case, it is possible to reduce or avoid inaccuracies that may be generated by a relative movement between the two parts, when recalling that such relative movement (especially is substantial, e.g. going beyond vibrations, etc.) may alter the intensity of the magnetic field detected by the sensor and thus lead to a wrong determination that the maximum temperature has been reached.

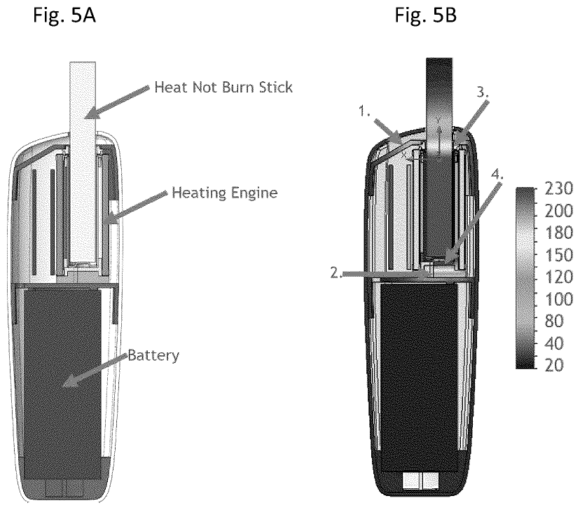

Preferably, the maximum operating temperature of the magnet 10 may correspond to a safe operating temperature at a location where the magnet is placed. For example, let us consider the case of placing the magnet 10 at a location corresponding to a heater included in the aerosol generative device, e.g. on the heater, in proximity of the heater, within the heater or as part of the heater, as also later explained with reference to FIG. 5 et seq. In this case, the location where the magnet is placed and/or the material of the magnet are determined so that the maximum operating temperature of the magnet 10 corresponds to a safe operation of the heater, e.g. in order to avoid the user getting burned when the heater is malfunctioning or damaged. Thus, when the heater's temperature becomes excessive (e.g. exceeds a value that is consider unsafe for the user and that corresponds to the maximum operating temperature of the magnet 10) the disabling unit 30 intervenes to disable operation. In another example, a component like a battery of the aerosol generating device 10 is to be protected, e.g. against overheating due to malfunctioning: The magnet 10 may be placed in proximity of the battery and/or the material of the magnet 10 chosen so that the maximum operating temperature of the magnet 10 corresponds to a maximum functioning temperature of the battery that is considered to be safe for the operation of the battery. Hence, the maximum operating temperature of the magnet is set to correspond to a maximum functioning temperature of the aerosol generating device or components thereof, wherein such correspondence may be set by determining the location (position) where the magnet is placed and/or the material of the magnet. The maximum functioning temperature may be set in view of safety for the user and/or of safety operation of the aerosol generating device or of components thereof.

Preferably, the aerosol generating device 1 may further include a temperature measurement unit configured to provide a measure of temperature based on a value of the magnetic field sensed by the sensor. In fact, especially for temperatures below or up to the maximum operating temperature of the magnet 10, the magnetic field produced by the magnet 10 may vary with temperature according to a known magnetic field-temperature profile; thus, by measuring the magnetic field, it is possible to determine the temperature of the magnet and the corresponding temperature of the location and component of the device where the magnet is placed. Thus, an additional function can be provided by using the same means. The temperature measurement unit may be conveniently (but not necessarily) implemented within the sensor or within a processor/controller also implementing the disabling unit. In this way, one single arrangement (e.g. the magnet with the sensor, or the magnet with the processor) can be conveniently used as a fuse and as a temperature measuring unit thus reducing the number of components needed to perform the corresponding functions of e.g. measuring temperatures and ensuring safe operation.

As above anticipated, and now with reference to FIG. 1A, in one example the aerosol generating device preferably includes a heating unit 40, wherein the magnet 10 is placed in proximity of and/or in (mechanical) contact (e.g. the magnet at least partially touches the heater) with and/or within the heating unit 40. As also below illustrated with examples, the magnet may have a body that is partially in proximity, partially in touch, or partially within the heater (or the magnet may be realized by multiple magnet units producing a collective field detected by the sensor 20). In this way, the magnet 10 may be used to ensure that operation is disabled when the heater reaches a predetermined temperature that is deemed not appropriate, for example in view of the risk of burning the user, of the risk that excessive current is drawn from the battery leading to possible malfunctioning, etc.

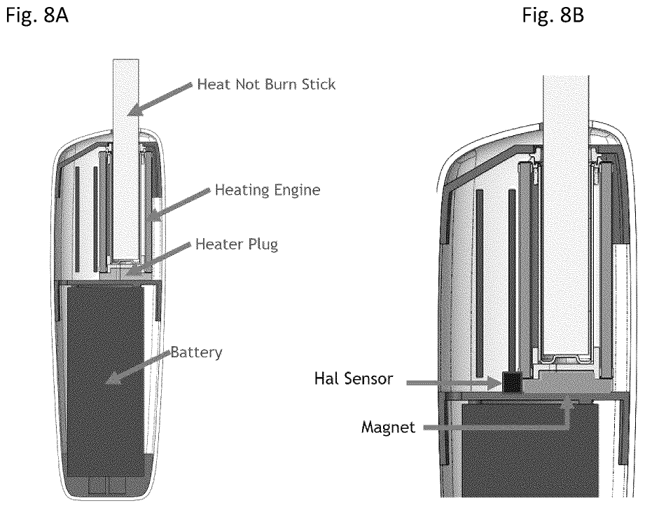

Preferably, when the magnet is placed within the heating unit, the magnet may be integrated as part of the construction of the heating unit, preferably as part of a wall of the heating unit or as part of a supporting member of the heating unit as also illustrated further below. Preferably, the aerosol generating device 1 may include a plug (as depicted in e.g. FIG. 8B) for closing the heater at the end opposite to the inlet where a consumable (e.g. a stick) is inserted into the heater: In this example, the magnet may be integrated as part of the plug 45 so as to be in direct contact with the heater and act as a sink thus providing a simple and accurate construction.

In one example, also with reference to FIG. 1B, the aerosol generating device preferably includes a battery, and the magnet is placed in proximity of and/or in contact with the battery. In this way, a safe operation of the device can be provided by disabling operation when the temperature of the battery reaches a maximum functioning temperature deemed not appropriate for a safe and/or proper functioning, wherein the maximum operating temperature of the magnet 10 is set (as above stated, by appropriately determining the placing location and/or material of the magnet) to correspond to the maximum functioning temperature.

Preferably, the disabling unit 30 includes a switch connected in series to the battery and that is configured to be an open position when the magnetic field is below the magnetic field threshold. In one example, the switch may be implemented by a transistor as above illustrated.

It is noted that while the magnet 10 may be realized by a single magnet unit, multiple magnet units may be used as also above illustrated with reference to the heater example and when noting that the same applies to other examples (e.g. multiple battery units placed at different positions relatively to the battery or other components to protect).

Further, the aerosol generating device has been illustrated the above as one capable of receiving a stick and heating it. The present solution(s) is (are) however not limited to such type of device as it in fact applies also to other aerosol generating devices that include components for which a safe operation wants to be ensured, when noting that such devices preferably or usually include components like a heater and/or battery, etc. Further, the aerosol generating device may also be named inhaler, etc. Preferably, the aerosol generating device is for generating a tobacco containing aerosol; preferably, the aerosol generating device is for generating aerosol from a substance source containing a flavour and/or a substance source containing tobacco.

What has been stated above including optional and preferable aspects accordingly applies to the embodiments disclosed below, and vice versa. Repetitions of the same or respective explanations will be accordingly omitted for the sake of conciseness. Accordingly, same numerals refer to the same features and corresponding explanations unless otherwise noted.

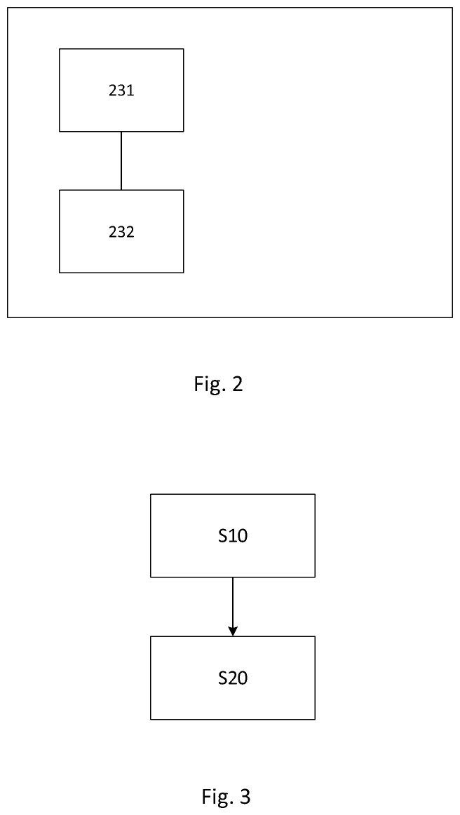

With reference to FIG. 2, a disabling unit 230 according to a second embodiment is illustrated. The disabling unit 230 is for disabling operation of an aerosol generating device including a magnet and/or for disabling operation of an accessory apparatus of an aerosol generating device, wherein the accessory apparatus includes a magnet. The disabling unit 230 includes a processing unit 231 and a notification unit 232. The disabling unit 230 may also be interchangeably called safety unit for putting the device in a safety state (safety mode). In the safety state/mode, operation may be disabled preferably permanently or at least until a specific overriding command is provided.

The processing unit 231 is configured to determine a disablement condition in correspondence of a magnetic field value (e.g. as detected by a sensor 20 coupled to the magnet 10) of the magnet being below a predetermined magnetic field threshold. The predetermined magnetic field threshold includes a value indicating an intensity of the magnetic field exhibited by the magnet in correspondence of a maximum operating temperature of the magnet. The maximum operating temperature of the magnet indicates a temperature value above which the magnet loses magnetic properties. The disablement condition may be obtained based on a sensor output provided by a sensor 20 as the one described above. Accordingly, the disablement condition may represent or correspond to an indication that the magnetic field of the magnet is absent or that the magnetic field of the magnet is below a predetermined threshold; hence, the disablement condition represents or corresponds to the fact that the temperature of the aerosol generating device or a component thereof has reached the maximum operating temperature, e.g. has reached a state where operation may not be safe.

The notification unit 232 is configured to issue, in response to the determination f a presence of the disablement condition, a notification signal indicating that operation of the aerosol generation device or that operation of the accessory apparatus is to be disabled.

In one example, the disabling unit 230 may be implemented by a controller including a processor (as an example of the processing unit 231) and an interface port (as an example of the notification unit 232) for issuing a command to disable a device or for issuing a signal notifying another device to disable the the aerosol generation device. The notification signal may be represented by a signal issued by a controller, for example to disable heating or to disconnect the battery from other circuit components. In another example, the disabling unit 230 may be implemented by a circuit including a transistor which gate is provided with a signal indicating a disabling condition (as provided e.g. and by the connectable terminals of the by a sensor) transistor notifying, e.g. by switching to an open state, that operation is to be disabled/suspended when the disabling condition is met.

An example of the above-mentioned accessory apparatus of the aerosol generating device includes a pocket charger containing a battery for recharging the aerosol generating device, wherein the magnet may be installed in proximity of the battery of the pocket charger.

With reference to FIG. 3, it now illustrated a third embodiment relating to a method for disabling operation of an aerosol generating device 1 including a magnet 10. The method includes a step S10 of measuring, by means of a sensor 20 coupled to a magnet 10 included in the aerosol generating device 1, a value of a magnetic field generated by the magnet 10.

The method further includes a step S20 of disabling operation of the aerosol generating device 1 in correspondence of a magnetic field value being below a predetermined magnetic field threshold. The predetermined magnetic field threshold includes a value indicating an intensity of the magnetic field exhibited by the magnet 10 in correspondence of a maximum operating temperature of the magnet 10; the maximum operating temperature of the magnet 10 indicates a temperature value above which the magnet 10 loses magnetic properties.

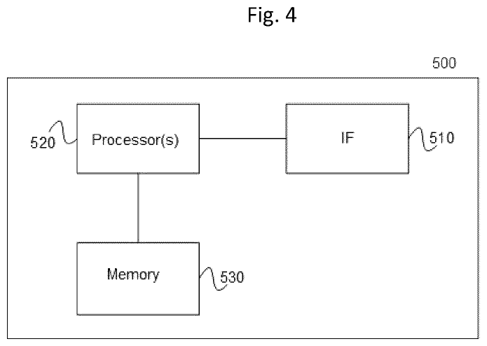

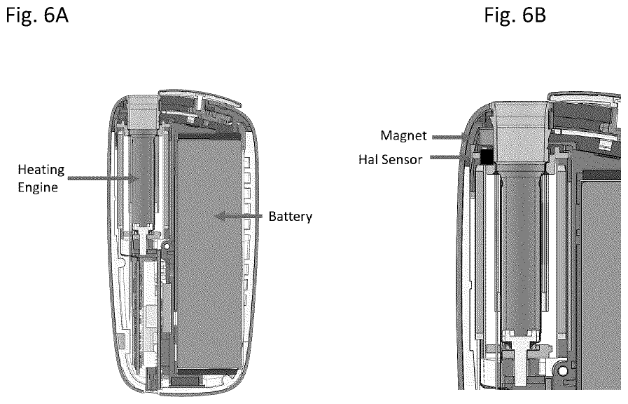

According to another embodiment, there is provided a processor program comprising instructions configured to execute, when the program is run on a computer, any step or combination of steps of the method and the variants thereof as described with reference to the first embodiment. FIG. 6 illustrates a block diagram exemplifying a computer 500 capable of running the aforesaid program. In particular, the computer 500 comprises a memory 530 for storing the instructions of the program and/or data necessary for the execution thereof, a processor 520 for executing the instructions and an input/output interface 510. FIG. 4 provides an illustration of a computer suitable for executing such a computer program.

According to a further embodiment, a medium is provided for supporting a processor program comprising instructions configured to execute, when the program is run on a computer, a step or a combination of steps according to the method described above. Examples of a medium are a static and/or dynamic memory, a fixed disk or any other medium such as a CD, DVD, Blue Ray (from where the instructions are copied in a processor of the aerosol generation device or its accessory). Comprised in the medium there is also a means capable of supporting a signal constituting the instructions, including a means of cable transmission (Ethernet, lens, etc.) or wireless transmission (cellular, satellite, digital terrestrial transmission, etc.).

In the following, examples are illustrated wherein the sensor 20 is a Hall sensor (when recalling that other sensors might be used as long as they are suitable for measuring a magnetic field preferably by placing the sensor in proximity of the magnet).

As it follows from the above explanations, a Hall sensor may be used to detect a magnetic field generated by a magnet (typically and preferably a hard magnetic material) in the device and stopping the device from being used once the magnetic field cannot be detected due to the magnetic material reaching its maximum operating temperature (see also later description with reference to table 1). The magnet will become permanently demagnetized if heated higher than its maximum operating temperature, thus acting like a fuse.

Heat demagnetization depends on the magnet material. Some types of magnets such as Samarium-cobalt (SmCo) have higher heat resistance and might be particularly indicated for application to an aerosol generating device. Nyodienium magnets could be used as well, though perhaps not in the hottest places of the aerosol generating device like a HNB device.

The magnet's maximum operating temperature preferably corresponds to the safe operating temperature of the device at the magnet's location (i.e. at the location where the magnet is placed) and a Hall sensor is placed where the magnet's magnetic properties can be detected. If the device overheats and, if present, other optional sensors (such as a thermistor) fail to sense this, the temperature at the location of the magnet will surpass the magnet's operating temperature and in turn, the Hall sensor will detect a lower magnetic field, thus triggering the disabling of the device to make it inoperable.

The level of magnetization detected by the Hall sensor also acts as a wireless temperature sensor until the magnet has reached its maximum operating temperature (e.g. Nyodienium magnets lose 0.11% of their magnetism for every 1 degree Celsius rise in temperature; based on the known temperature-magnetic field profile, the temperature can be obtained from a measured magnetic field at a given point in time). One advantage of this solution is that it allows the magnet to be placed in areas where normal electronic components cannot be placed (e.g. cables for connecting to a temperature sensor cannot be placed inside the heater/oven) and/or used/integrated as part of the construction of the device such as the heater walls (cup) or supporting parts of the heating engine (i.e. the oven plug). In the latter case, it is also possible to achieve a compact design.

The present solution may also be used to protect critical components of the aerosol generating device such as the battery by placing the magnet close to where the temperature can be monitored to best protect the critical component.

The following Table 1 is an example of different types of magnets and their corresponding maximum operating temperatures:

| | | Max. Working Temperature |
|---|---|---|
| MAGNET TYPE SUFFIX | | (based on High working point) |
| 1. | No suffix | 80° C. = 176° F. * |
| | M | 100° C. = 212° F. |
| 2. | H | 120° C. = 248° F. |
| | SH | 150° C. = 302° F. |
| 3. | UH | 180° C. = 356° F. |
| | EH | 200° C. = 392° F. |
| 4. | AH | 230° C. = 446° F. |

* 60° C. for N50 and N52

For a discussion on neodymium magnet grades, reference is made to for example https://en.wikipedia.org/wiki/Neodymium magnet; or “Handbook of Modern Sensors: Physics, Designs, and Applications”, Jacob Fraden, Springer; https://e-magnetsuk.com/introduction-to-neodymium-magnets/grades-of-neodymium/for a list of neodymium magnets having nomenclature starting with “N” (which stands for NEO, the industry simplification for Neodymium) and followed by a two-digit number; or https://e-magnetsuk.com/introduction-to-neodymium-magnets/temperature-ratings/indicating temperature effects on Neodymium iron Boron, NdBFeC, magnets.

FIG. 5A shows a cross section of an exemplary Heat Not Burn (HNB) device. FIG. 5B shows a maximum device operating temperatures heat map, i.e. a map indicating which are the maximum temperatures reached during a limit safe operation at respective positions of the HNB device; the limit safe operation indicates an upper limit of values which, if exceeded, cause a non-safe operation. Reference numbers 1 to 4 indicate magnets with varying operating temperatures (the numbers 1 to 4 refers to those indicated in the left column of table 1) in their appropriate position to act as safety fuse and temperature sensor. For example, at the inlet of the heater where a temperature in the range of ca. 150° C.-180° C. can be reached (see reference 3 in FIG. 5), a magnet having material type suffix UH or EH is determined to be appropriate and thus selected (see the rows corresponding to reference 3 in table 1 above); in fact, the maximum operating temperature of the magnet type UH is approx. 180° C., so that it loses magnetic properties in correspondence of the maximum temperature tolerated at that position. In the same position, material type EH may be chosen when the limit safe operation can be increased, or when a tolerance can be added to the limit sage operation. Similar considerations apply to reference numbers 1, 2 and 4 of FIG. 5 indicating temperature ranges of approx. 80° C.-100° C., 120° C.-150° C. and 230° C., respectively, for which magnet type suffix M (for reference 1), H or SH (for reference 2) and AH (for reference 4) are selected. The location of the magnet can be adjusted to match the maximum safe operating temperature of the device according to the heat map and/or to tests made on the device, etc. These are examples showing how the magnet location and/or the magnet material are determined in order to detect whether an unsafe operation is reached.

FIG. 6A shows a schematic block of an HNB device including a heating engine (an example of a heater) and a battery. For this configuration, FIG. 6B shows an example where the magnet is placed outside the heater (oven), the battery not being shown since not immediately relevant to the example (it may in fact be omitted). As it can be seen from FIG. 6B, the Hall sensor is places in proximity and below the magnet, so that the temperature reached by the sensor may be lower than the temperature reached by the magnet, which makes the construction of the sensor simpler. Also, for temperature below the maximum operating temperature of the magnet, the sensor may be said to measure the temperature in a “wireless” manner, since no cables are required, which makes the construction easier and more compact since the same arrangement is used as a safety fuse and as a temperature measuring unit.

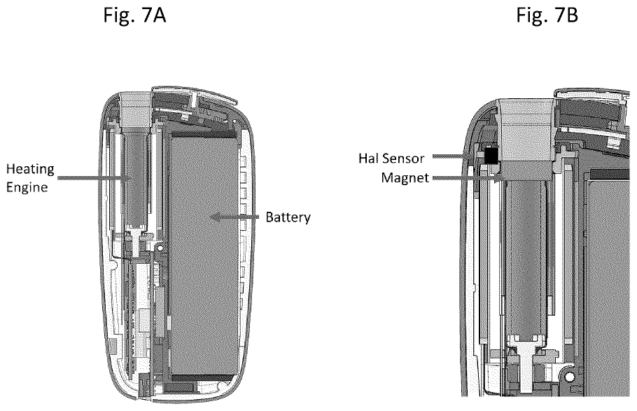

FIG. 7A shows a schematic block of an HNB device including a heating engine (an example of a heater) and a battery. For this configuration, FIG. 7B shows an example where the magnet is part of the heater construction, for example part of the heater cup construction. One advantage of this configuration is that one can integrate the material to an existing part of the heater without requiring additional parts and thus rendering the HNB device more compact. Also in this case, the Hall sensor is placed in proximity and may reach a temperature lower than the one of the heater and magnet therein integrated, so that construction of the sensor may be easier to realize (the same applies also for the following examples). Also in this case, a wireless temperature measurement may be implemented (the same applies also for the following examples, so that repetitions are avoided).

FIG. 8A shows a schematic block of an HNB device including a heating engine (an example of a heater) and a battery. For this configuration, FIG. 8B shows an example where the magnet is provided as a heater (oven) plug, i.e. at the bottom of the heater (bottom relatively to the device when held in a vertical position with the inlet of the heater upside). One advantage of this configuration lies in that the magnet in direct contact with the heater and acts as heatsink, so that an accurate monitoring of the temperature conditions (and thus of risky conditions) can be achieved.

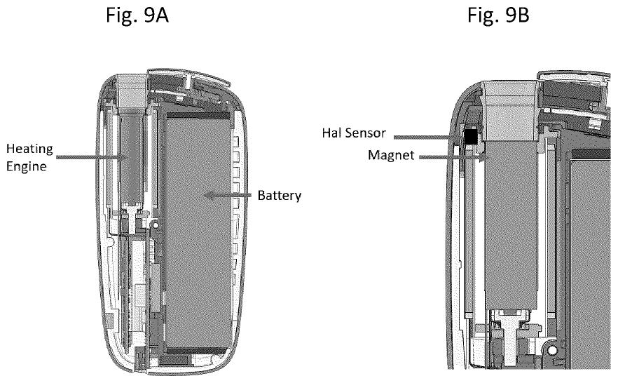

FIG. 9A shows a schematic block of an HNB device including a heating engine (an example of a heater) and a battery. For this configuration, FIG. 9B shows a heater cup made from magnetic material as part thereof (e.g. integrating a magnet). Some of the advantages lie in that this configuration does not require additional parts and that it is possible detecting the temperature at the source of heat, thus having a simple and accurate construction.

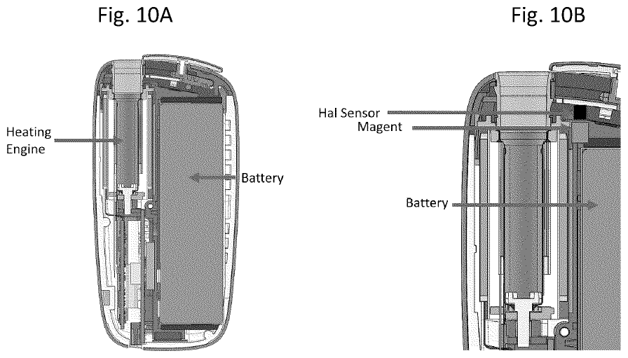

FIG. 10A shows a schematic block of an HNB device including a heating engine (an example of a heater) and a battery. For this configuration, FIG. 10B shows the case wherein the Hall sensor is placed in proximity or touching the battery, so that it is possible monitoring temperatures on a critical component such as battery. The examples above shown may be combined. For example, protection against one component may be achieved by placing different magnets at different positions of the component (see the heater case), protection against multiple components may be achieved by placing one or more magnets for each of the components (e.g. one or more magnets for the heater, and one or more magnets for the battery).

What has been explained above may be applied to other components of the aerosol generating device beyond the heater and the battery.

In the above description, what has been disclosed for devices applies also to a respective method or to respective methods, and vice versa. Further, features like a magnet, a sensor, a disabling unit, a processing unit and a notification unit are not limited to a specific implementation and these wordings may be replaced, respectively, by corresponding magnetic generating means for generating a magnetic field, sensing means, disabling means, processing means and notification means. Naturally, the description set forth herein above concerning embodiments and examples that apply the principles recognized by the inventors is provided solely by way of example of these principles and therefore it should not be understood as a limitation of the scope of the invention claimed herein. Thus, although detailed embodiments and examples have been described, they only serve to provide a better understanding of the invention defined by the independent claims, and are not to be seen as limiting.

Further examples can be described as follow:
E1. An aerosol generating device (1) including:
   a magnet (10) configured to generate a magnetic field;
   a sensor (20) coupled to the magnet and configured to sense a value of a magnetic field generated by the magnet;
   a disabling unit (30) configured to disable operation of the aerosol generating device, wherein
   the disabling unit (30) is configured to disable operation of the aerosol generating device (1) in correspondence of a magnetic field value detected by the sensor (20) being below a predetermined magnetic field threshold, wherein the predetermined magnetic field threshold includes a value indicating an intensity of the magnetic field exhibited by the magnet (10) in correspondence of a maximum operating temperature of the magnet (10), the maximum operating temperature of the magnet indicating a temperature value above which the magnet loses magnetic properties.
E2. The aerosol generating device (1) of example 1, wherein the magnet (10) and the sensor (20) are in a fixed position relatively to each other.
E3. The aerosol generating device (1) of example E1 or E2, wherein the maximum operating temperature of the magnet (10) corresponds to a safe operating temperature at a location where the magnet (10) is placed.
E4. The aerosol generating device (1) of any of the preceding examples, the aerosol generating device further including a temperature measurement unit (30) configured to provide a measure of temperature based on a value of the magnetic field sensed by the sensor (20).
E5. The aerosol generating device (1) of any of the preceding examples, the aerosol generating device further including a heating unit (40), wherein the magnet (10) is placed in proximity of and/or in contact with and/or within the heating unit (40).
E6. The aerosol generating device (1) of example E5, wherein the magnet (10) being placed within the heating unit includes the magnet (10) being integrated as part of the construction of the heating unit (40), preferably as part of a wall of the heating unit (40) or as part of a supporting member of the heating unit (40) or as part of a plug of the heating unit (40).
E7. The aerosol generating device (1) of any of the preceding examples, the aerosol generating device further including a battery, wherein the magnet (10) is placed in proximity of and/or in contact with the battery.
E8. The aerosol generating device (1) of any of the preceding examples, wherein the disabling unit includes a switch connected in series to the battery and that is configured to be an open position when the magnetic field is below the magnetic field threshold.
E9. A disabling unit (230) for disabling operation of an aerosol generating device (1) including a magnet (10) or operation of an accessory apparatus of an aerosol generating device (1), the accessory apparatus including a magnet (10), the disabling unit (1) including:
   a processing unit (231) configured to determine a disablement condition in correspondence of a magnetic field value of the magnet being below a predetermined magnetic field threshold, wherein the predetermined magnetic field threshold includes a value indicating an intensity of the magnetic field exhibited by the magnet in correspondence of a maximum operating temperature of the magnet, the maximum operating temperature of the magnet indicating a temperature value above which the magnet loses magnetic properties;
   a notification unit (232) configured to issue, in response to the determination of a presence of the disablement condition, a notification signal indicating that operation of the aerosol generation device or that operation of the accessory apparatus is to be disabled.
E10. The disabling unit (230) according to example E9, wherein the disabling unit is configured to receive, from a temperature measurement unit, a measure of temperature based on a value of the magnetic field sensed by the sensor (20).
E11. The disabling unit (230) according to example E9 or E10, wherein the disabling unit includes a switch connected in series to the battery and that is configured to be an open position when the magnetic field is below the magnetic field threshold.
E12. A method for disabling operation of an aerosol generating device including a magnet, the method comprising the steps of:
   Measuring (S10), by means of a sensor coupled to a magnet included in the aerosol generating device, a value of a magnetic field generated by the magnet;
   disabling (S10) operation of the aerosol generating device in correspondence of a magnetic field value being below a predetermined magnetic field threshold, wherein the predetermined magnetic field threshold includes a value indicating an intensity of the magnetic field exhibited by the magnet in correspondence of a maximum operating temperature of the magnet, the maximum operating temperature of the magnet indicating a temperature value above which the magnet loses magnetic properties.
E13. The method of example E12, further including a step of measuring a temperature (corresponding to the temperature at a location where the magnet is placed) based on a value of the magnetic field sensed by the sensor (20).
E14. The method of example E12 or E13, the aerosol generating device further including a heating unit, wherein the method includes placing the magnet in proximity of and/or in contact with and/or within the heating unit.
E15. A computer program including instructions which, when executed on a computer, cause the computer to perform the steps of any of examples E12 to E14.

1. An aerosol generating device including:
a magnet configured to generate a magnetic field;
a sensor coupled to the magnet and configured to sense a value of a magnetic field generated by the magnet; and
a disabling unit configured to disable operation of the aerosol generating device, wherein
the disabling unit is configured to disable operation of the aerosol generating device in correspondence of a magnetic field value detected by the sensor being below a predetermined magnetic field threshold, wherein the predetermined magnetic field threshold includes a value indicating an intensity of the magnetic field exhibited by the magnet in correspondence of a maximum operating temperature of the magnet, the maximum operating temperature of the magnet indicating a temperature value above which the magnet loses magnetic properties; and
the aerosol generating device further includes a temperature measurement unit configured to provide a measure of temperature based on a value of the magnetic field sensed by the sensor.

2. The aerosol generating device of claim 1, wherein the magnet and the sensor are in a fixed position relatively to each other.

3. The aerosol generating device of claim 1, wherein the maximum operating temperature of the magnet corresponds to a safe operating temperature at a location where the magnet is placed.

4. The aerosol generating device of claim 1, further comprising a heating unit, wherein the magnet is placed in proximity of and/or in contact with and/or within the heating unit.

5. The aerosol generating device of claim 4, wherein the magnet being placed within the heating unit includes the magnet being integrated as part of the construction of the heating unit.

6. The aerosol generating device of claim 1, further comprising a battery, wherein the magnet is placed in proximity of and/or in contact with the battery.

7. The aerosol generating device of claim 6, wherein the disabling unit includes a switch connected in series to the battery and that is configured to be in an open position when the magnetic field is below the magnetic field threshold.

8. A disabling unit for disabling operation of an aerosol generating device including a magnet or operation of an accessory apparatus of an aerosol generating device, the accessory apparatus including a magnet, the disabling unit including:
a processing unit configured to determine a disablement condition in correspondence of a magnetic field value of the magnet being below a predetermined magnetic field threshold, wherein the predetermined magnetic field threshold includes a value indicating an intensity of the magnetic field exhibited by the magnet in correspondence of a maximum operating temperature of the magnet, the maximum operating temperature of the magnet indicating a temperature value-above which the magnet loses magnetic properties;
a notification unit configured to issue, in response to the determination of a presence of the disablement condition, a notification signal indicating that operation of the aerosol generation device or that operation of the accessory apparatus is to be disabled;
wherein the disabling unit is configured to receive, from a temperature measurement unit, a measure of temperature based on a value of the magnetic field sensed by a sensor of the aerosol generating device.

9. The disabling unit according to claim 8, further comprising a switch configured to be connected in series to a battery of the aerosol generating device and that is configured to be in an open position when the magnetic field is below the magnetic field threshold.

10. A method for disabling operation of an aerosol generating device including a magnet, the method comprising the steps of:
measuring, by a sensor coupled to a magnet included in an aerosol generating device, a value of a magnetic field generated by the magnet;
disabling operation of the aerosol generating device in correspondence of a magnetic field value being below a predetermined magnetic field threshold, wherein the predetermined magnetic field threshold includes a value indicating an intensity of the magnetic field exhibited by the magnet in correspondence of a maximum operating temperature of the magnet, the maximum operating temperature of the magnet indicating a temperature value-above which the magnet loses magnetic properties; and
measuring a temperature (corresponding to the temperature at a location where the magnet is placed based on a value of the magnetic field sensed by the sensor.

11. The method of claim 10, wherein the aerosol generating device further includes a heating unit, wherein the method includes placing the magnet in proximity of and/or in contact with and/or within the heating unit.

12. A non-transitory computer program including instructions which, when executed on a computer, cause the computer to perform the steps of claim 10.

13. The aerosol generating device of claim 4, wherein the magnet being placed within the heating unit includes the magnet being integrated as part of the construction of the heating unit, as part of a wall of the heating unit or as part of a supporting member of the heating unit or as part of a plug of the heating unit.
